(19) United States
(12) Patent Application Publication
(10) Pub. No.: US 2015/0104596 A1
(43) Pub. Date: Apr. 16, 2015

(54) Coded cuttable strips for individualizing material samples

(71) Applicant: Ulrich Felix Vogel, Tuebingen (DE)

(72) Inventor: Ulrich Felix Vogel, Tuebingen (DE)

(21) Appl. No.: 14/356,152

(22) PCT Filed: Nov. 3, 2011
(86) PCT No.: PCT/DE2011/001931

§ 371 Date: May 3, 2014

(51) Int. Cl. G09F 3/00; G01N 1/36

(52) U.S. Cl. CPC G09F 3/0297; G01N 1/36; G01N 2001/366
USPC 428/36.9; 428/542.6; 428/195.1; 428/34.1; 428/36.92

(57) ABSTRACT

Prior art for processing human cell or tissue biopsy specimens implies the individualization of the specimens by marking the specimen containers (e.g. for transportation) and the specimen holders (e.g. plastic cassettes, glass slides) but not the specimen itself. The specimen processing steps include several manual transfers of the specimens between different containers and specimen holders. This manual transfer may result in specimen mix-ups. These specimen mix-ups can be prevented by attaching solvent resistant uni- or multicolored barcoded cuttable strips of cellulose acetate directly to the specimens thereby marking and individualizing the specimen itself. The strips adhere to the specimens at all steps of tissue processing and evaluation.

This patent application is the U.S. National Stage of International Application No. PCT/DE2011/001931 filed Nov. 3, 2011.

The invention relates to a process for the identification and individualization of samples, particularly of cell and tissue samples, by an in particular strip- or blockshaped, on a microtome or ultramicrotome cuttable, coded material.

Particularly in the field of human pathology, the structure of cell and tissue samples is examined by light microscopy. Until the final examination under the microscope the samples are processed in several steps (including e.g. the tissue sampling and removal out of the body by a clinical physician, the transport of the sample in a container to the institute of pathology, the unbagging of the sample from the container for macroscopic evaluation, the transfer of the sample into a plastic cassette for paraffinization, the installment of the sample into a steel embedding mold for the construction of a paraffin block, the mounting of a section onto a slide), at which the samples are stored in different containers and sample holders (e.g. slides). So far, only the containers or the sample holders are marked and thereby individualized (e.g. by numbers), but not the samples. For this reason, sample mix-ups which may occur at the different processing steps with a manual transfer of the samples e.g. from one container to another, can easily happen and are hardly to detect.

By the present invention, however, the sample material is uniquely marked immediately after the removal from the body by adhering to a strip- or blockshaped material which can be cut on a microtome or ultramicrotome. This strip- or blockshaped material is characterized by e.g. a uni- or multicolored barcode or a special form or structure. Therefore, the sample can be clearly identified even on the slide. It is advantageous if the material adheres to the sample by capillary force, friction or covalent binding according to the kind of material.

These basic considerations also apply to plant or animal or inorganic specimens.

Cellulose acetate may represent such a material which can be cut, adheres to a sample and can be clearly marked and identified. A so-called EndoKit is distributed by the company BioOptica, Milano, Italy. This EndoKit consists of strips of cellulose acetate of a dimension of 30×5×0.1 mm, which adhere to e.g. fresh, only slightly moistened tissue samples. After formalin fixation these samples with the adhering strip of cellulose acetate are put into a plastic cassette for paraffinization of the tissue during the macroscopic examination step. At the construction process of the paraffin block the paraffinized samples can be accurately aligned and identified by means of the cellulose acetate strip. The strip of cellulose acetate can be subsequently cut on a microtome and e.g. detected by light microscopy.

The novelty of the present invention is the application of an unique marking on the cellulose acetate strip e.g. in the form of a uni- or multicolored barcode. This barcode can be read at all steps of sample processing e.g. by the naked eye or a scanner with an appropriate software. Thus, it is ensured at every processing step that e.g. by using appropriate scanners with a suited software the samples being uniquely marked by the cellulose acetate strip are placed into the correspondent containers for further processing. Furthermore, the barcode may be scanned on the sections, providing a correct mounting of the sections on the labeled slides.

By using the present invention a sample mix-up can be prevented from the removal of the sample out of the body till the last processing step, e.g. the histological examination under the microscope, by a unique marking of the tissue and the correspondent containers or slides.

Other materials that could be used for the identification of tissues are, for example, other biological materials (e.g. animal tissue, agar) and cuttable plastics. In order to improve the adhesion of the marking material to the slide in particular in the setting of specific tissue pretreatment procedures e.g. for immunohistochemistry, the agar and the cellulose acetate may be dotted with cells or tissue fragments or other biological materials such as animal tissue can be used.

Depending on the requirements, the material used for marking may have the form of a strip, a block, a box, an U, an angle or a tube.

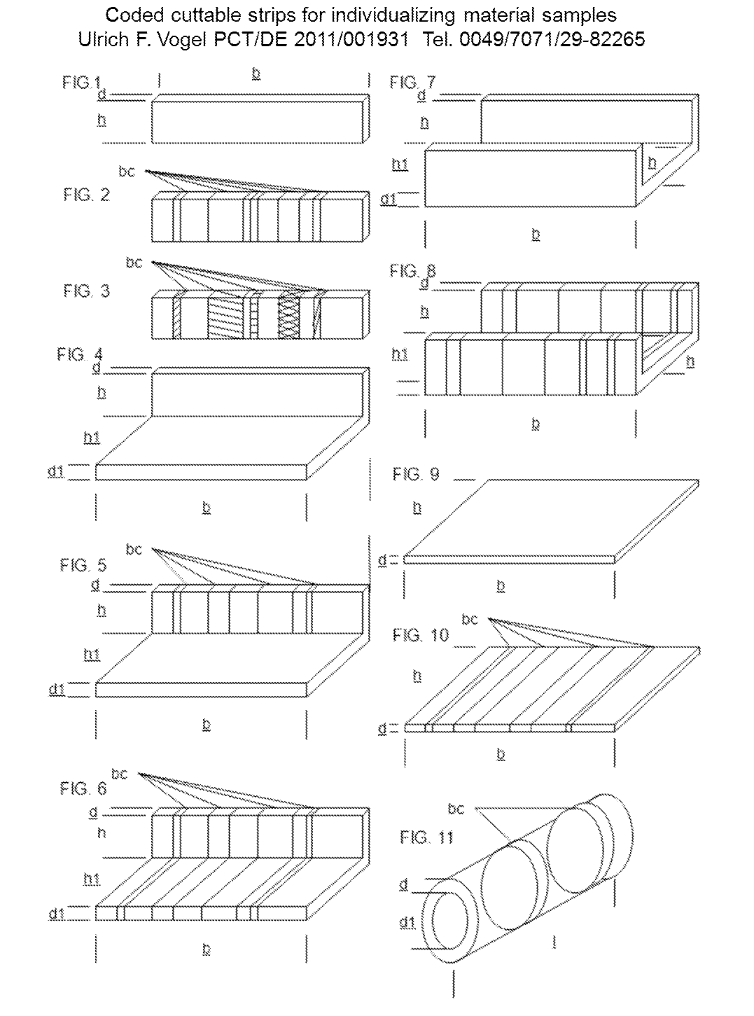

Possible shape variants of the material are displayed in FIGS. 1 (strip- or block-shaped), 4 (angle-shaped), 7 (U-shaped), 9 (sheet-shaped) and 11 (tube shaped) which may be marked with a unicolored (FIGS. 2, 5, 6, 8, 10, 11) or multicolored (here differently shaded) (FIG. 3) barcode.

Abbreviations used in the figures:

b width
d thickness
h height
t depth
l length
bc barcode
dm diameter

1. On a microtome or ultramicrotome cuttable material e.g. in the form of a sheet, a strip, a block, a box or a tube, characterized in that it can be used for reliable identification of samples such as cell and/or tissue material by applying a unique structural or color coding.

2. Material according to claim 1, characterized in that it adheres, such as cellulose acetate, due to capillary forces and friction forces to the tissue.

3. Material according to claim 1, characterized in that it forms a cohesive or adhesive-like bond to the tissue.

4. Material according to claim 1, characterized in that it can be molded together with the tissue into an e.g. agar block.

5. Material according to claim 1, characterized in that the marking is carried out in the form of a mono-or multi-colored bar code.

6. Material according to claim 1, characterized in that the marking is stable in both the aqueous phase and the fatty phase and, in particular solvent resistant.

7. Material according to claim 1, characterized in that the labeling can be read macroscopically and/or microscopically and/or optoelectronically for example by a scanner.

8. Material according to claim 1, characterized in that it sticks better to slides by adding cell and tissue material.

9. Material according to claim 1, characterized in that any three-dimensional shape can be used to mount the tissue.
